(19) United States
(12) Patent Application Publication
(10) Pub. No.: US 2026/0244563 A1
(43) Pub. Date: Aug. 20, 2026

(54) SEPARATED DEALLOCATION PROCESSING FOR MEMORY SUB-SYSTEMS

(71) Applicant: Micron Technology, Inc., Boise, ID (US)

(72) Inventor: Donghua Zhou, Suzhou City (CN)

(21) Appl. No.: 19/054,548

(22) Filed: Feb. 14, 2025

(51) Int. Cl. G06F 12/02

(52) U.S. Cl. CPC G06F 12/0246; G06F 2212/7201; G06F 2212/7202

(57) ABSTRACT

A deallocation command for a range of logical addresses corresponding to one or more regions of a memory device is received. In response to the deallocation command, multiple operations are performed in foreground processing. The multiple operations include storing mapping information for the range of logical addresses, updating a logical-to-physical (L2P) mapping table by resetting L2P entries for the range of logical addresses, and setting valid translation unit count update flags for the one or more regions of the memory device corresponding to the range of logical addresses. Based on the setting of the valid translation unit count update flags, updates to valid translation unit counts for the one or more regions are performed in background processing based on the mapping information.

### TECHNICAL FIELD

Embodiments of the disclosure generally relate to memory sub-systems and, more specifically, to techniques for separated deallocation processing for memory sub-systems.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory sub-system, in accordance with some examples.

FIG. 2 is a data flow diagram illustrating interactions between components of the computing environment in performing a method for memory deallocation, in accordance with some examples.

FIG. 3 is a flowchart illustrating a method of storing mapping information for aligned regions during foreground deallocation operations, in accordance with some examples.

FIG. 4 is a flowchart illustrating a method of storing mapping information for unaligned regions during foreground deallocation operations, in accordance with some examples.

FIG. 5 is a flowchart illustrating a method of updating VTC values during background deallocation operations, in accordance with some examples.

FIG. 6 is a conceptual diagram that illustrates a process for merging mapping information when a region undergoes multiple deallocation operations before background processing completes, in accordance with some examples.

FIG. 7 is a flow diagram illustrating an example method for performing memory deallocation for a memory device, in accordance with some examples.

FIG. 8 is a flowchart illustrating a method of handling host read operations after deallocation processing, in accordance with some examples.

FIG. 9 is a flowchart illustrating a method of handling host write operations after deallocation processing, in accordance with some examples.

FIG. 10 is a block diagram of an example computer system in which embodiments of the present disclosure may operate.

### DETAILED DESCRIPTION

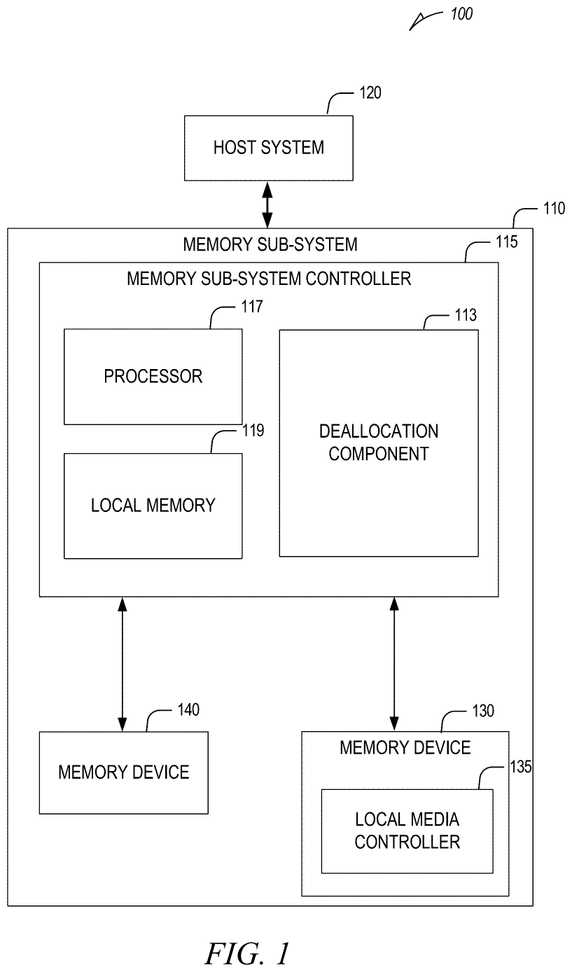

Aspects of the present disclosure are directed to an approach for performing memory deallocation in a memory device in a memory sub-system using separated processes. A memory sub-system can be a memory device (e.g., solid-state drive (SSD)), a memory module, or a combination of a memory device and memory module. Examples of memory devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system. A memory sub-system controller typically receives commands or operations from the host system and converts the commands or operations into instructions or appropriate commands to achieve the desired access to the memory components of the memory sub-system.

A memory device can be a non-volatile memory device. One example of a non-volatile memory device is a negative-and (NAND) memory device. A NAND memory device can include multiple NAND dies. Each die may include one or more planes, and each plane includes multiple blocks. Each block includes an array that includes pages (rows) and strings (columns). A string includes a plurality of memory cells connected in a series. A memory cell (also referred to herein simply as a “cell”) is an electronic circuit that stores information. Depending on the cell type, a cell can store one or more bits of binary information and has various logic states that correlate to the number of bits being stored. The logic states can be represented by binary values, such as “0” and “1,” or combinations of such values.

Various memory array operations can be performed on the memory cells. Data can be written to, read from, and erased from memory cells. Memory cells can be grouped into a write unit, such as a page. For some types of memory devices, a page is the smallest write unit. A page size represents a particular number of cells of a page. Data can be written to a block, page-by-page. During write operations, data is programmed into a block of the memory device using a programming sequence that includes multiple passes in which programming pulses are applied to cells in the block. Over the multiple passes, the programming pulses configure the threshold voltages (Vt) of the cells in each page according to the value that the cells are intended to represent. As the programming sequence progresses, the voltage level of the programming pulses increases until a target voltage level for each cell is reached.

Memory sub-systems allocate and deallocate storage space in memory devices to maintain optimal performance. Deallocation involves invalidating user data when it is no longer needed, which can be triggered by various operations such as namespace deletion, namespace formatting, or explicit host requests. Traditionally, deallocation operations typically involve two main processes: (1) updating a logical-to-physical (L2P) mapping table; and (2) managing a valid Translation Unit (TU) count (VTC). An L2P mapping table maintains the relationship between logical addresses presented to the host and physical locations in storage, while the VTC tracks how many valid translation units exist within each block stripe.

Conventional deallocation techniques treat L2P updates and VTC modifications as atomic operations that must be performed together. This approach requires maintaining deallocation states for each L2P region and implementing complex state management across multiple system modules including translation, L2P drop, and L2P recovery during power-on sequences, these conventional techniques also face challenges with host operations that conflict with ongoing deallocation processes. When a host write operation targets an address range that is currently being deallocated, the system must carefully manage the sequence of operations to maintain data consistency. This often requires implementing priority-based processing schemes that can significantly impact system performance.

Additionally, conventional deallocation implementations must handle various edge cases, such as unaligned deallocation requests that do not perfectly match L2P region boundaries. These scenarios require special handling and can introduce additional latency into the deallocation process. The management of block stripes presents another consideration in current memory sub-systems. As storage blocks are deallocated, the memory sub-system must accurately track valid data counts to enable efficient garbage collection and ensure optimal utilization of storage resources. This tracking becomes particularly important during power loss recovery scenarios, where the system must maintain consistency of both mapping information and valid data counts.

Aspects of the present disclosure address the above and other issues with a memory sub-system that separates the processes performed for memory deallocation into foreground and background processing. The memory sub-system performs foreground deallocation operations including storing mapping information for ranges of logical addresses, updating an L2P mapping table by resetting L2P entries, and setting VTC flags. The memory sub-system performs background deallocation operations including loading L2P information for selected regions, traversing L2P entries to update VTC values, and clearing VTC flags upon completion. This separation of operations allows the L2P entries to be reset during foreground processing while deferring the more time-intensive VTC updates to background processing. The memory sub-system maintains a bitmap to track which regions require VTC updates, where each bit corresponds to a region and indicates whether background deallocation is needed. When processing host operations after deallocation, the memory sub-system can directly use the reset L2P entries without checking additional flags since the mapping information is always current.

By performing L2P entry resets during foreground processing while deferring VTC updates to background processing, the memory sub-system achieves faster completion of deallocation commands while maintaining data consistency. The separation eliminates the need to check deallocation flags in the data path, which simplifies system implementation and reduces latency for host operations. Host read operations can directly determine deallocated status from L2P entry values without checking additional flags, while host writes can proceed without implementing priority deallocation since L2P entries always contain the latest mapping information. Bitmap-based tracking of regions requiring VTC updates enables efficient region selection during background processing, with the continuous memory implementation reducing overhead compared to other approaches. For unaligned deallocation commands that do not perfectly match L2P region boundaries, the memory sub-system reduces latency by storing only the deallocated portions of mapping information while clearing non-deallocated entries.

FIG. 1 illustrates an example computing environment 100 that includes a memory sub-system 110, in accordance with some embodiments of the present disclosure.

The memory sub-system 110 can include media, such as one or more volatile memory devices (e.g., memory device 140), one or more non-volatile memory devices (e.g., memory device 130), or a combination of such.

A memory sub-system 110 can be a memory device, a memory module, or a hybrid of a memory device and memory module. Examples of a memory device include an SSD, a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, and so forth.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize a Non-Volatile Memory Express (NVMe) interface to access the memory devices 130 and 140 when the memory sub-system 110 is coupled with the host system 120 by the PCIe or CXL interface. The physical host interface can provide an interface for passing control, address, data, and other signals between the memory sub-system 110 and the host system 120.

The memory devices can include any combination of the different types of non-volatile memory devices and/or volatile memory devices. The volatile memory devices (e.g., memory device 140) can be, but are not limited to, random-access memory (RAM), such as dynamic random-access memory (DRAM) and synchronous dynamic random-access memory (SDRAM).

An example of non-volatile memory devices (e.g., memory device 130) includes a NAND type flash memory. Each of the memory devices 130 can include one or more arrays of memory cells such as single level cells (SLCs), multi-level cells (MLCs) (e.g., triple level cells (TLCs), or quad-level cells (QLCs)). In some embodiments, a particular memory component can include an SLC portion, an MLC portion, a TLC portion, or a QLC portion of memory cells. Each of the memory cells can store one or more bits of data used by the host system 120. Furthermore, the memory cells of the memory devices 130 can be grouped as memory pages or memory blocks that can refer to a unit of the memory component used to store data.

Although non-volatile memory components such as NAND type flash memory are described, the memory device 130 can be based on any other type of non-volatile memory, such as read-only memory (ROM), phase change memory (PCM), magneto random access memory (MRAM), NOR flash memory, electrically erasable programmable read-only memory (EEPROM), and a cross-point array of non-volatile memory cells. A cross-point array of non-volatile memory can perform bit storage based on a change of bulk resistance in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

The memory sub-system controller 115 can communicate with the memory devices 130 to perform operations such as reading data, writing data, or erasing data at the memory devices 130 and other such operations. For example, the memory sub-system controller 115 can be coupled to any one or more of the memory devices 130 or 140 over a communication interface (not shown). The communication interface comprises multiple channels to facilitate communication between the memory sub-system controller 115 and the memory devices 130 and 140. In an example, the memory device 130 includes multiple dies and each die of the memory device 130 uses one of the channels to communicate with the memory sub-system controller 115. That is, a given die of the memory device 130 may communicate (e.g., send and receive data and commands) with the memory sub-system controller 115 over a channel of the communication interface dedicated to the die. In some examples, the communication interface comprises a data transfer interface such as an Open NAND Flash Interface (ONFI) bus. In some examples, the communication interface comprises a separate command-address (SCA) bus for the memory sub-system controller 115 to send commands to the memory devices 130 and 140.

The memory sub-system controller 115 can include hardware such as one or more integrated circuits and/or discrete components, a buffer memory, or a combination thereof. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and the like. The local memory 119 can also include ROM for storing micro-code. While the example memory sub-system 110 in FIG. 1 has been illustrated as including the memory sub-system controller 115, in another embodiment of the present disclosure, a memory sub-system 110 may not include a memory sub-system controller 115, and may instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address and a physical block address that are associated with the memory devices 130. The memory sub-system controller 115 can further include host interface circuitry to communicate with the host system 120 via the physical host interface. The host interface circuitry can convert the commands received from the host system into command instructions to access the memory devices 130 and convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130.

The memory sub-system 110 also includes a deallocation component 113 that is responsible for performing memory deallocation for the memory device 130 based on deallocation commands received from the host system 120. The deallocation component 113 separates deallocation operations into foreground and background processing to improve system performance. During foreground processing, the deallocation component 113 stores mapping information for ranges of logical addresses, updates the L2P mapping table by resetting L2P entries, sets VTC flags, and writes journal data. During background processing, the deallocation component 113 loads L2P information for selected regions, traverses L2P entries to update VTC values, and clears VTC flags upon completion. The deallocation component 113 maintains a bitmap data structure to track which regions need VTC updates, where each bit corresponds to a region and indicates whether background deallocation is needed.

When processing host read operations, the memory sub-system controller 115 checks mapping address validity and returns either the fetched data or special data patterns based on the mapping state. For host write operations, the memory sub-system controller 115 updates L2P entries and VTC values without checking additional deallocation flags since the mapping information is always current.

In some embodiments, the memory sub-system controller 115 includes at least a portion of the deallocation component 113. For example, the memory sub-system controller 115 can include a processor 117 (processing device) configured to execute instructions stored in local memory 119 (e.g., firmware) for performing the operations described herein. In some embodiments, the deallocation component 113 is part of the host system 120, an application, or an operating system. Further details regarding the deallocation component 113 are discussed below.

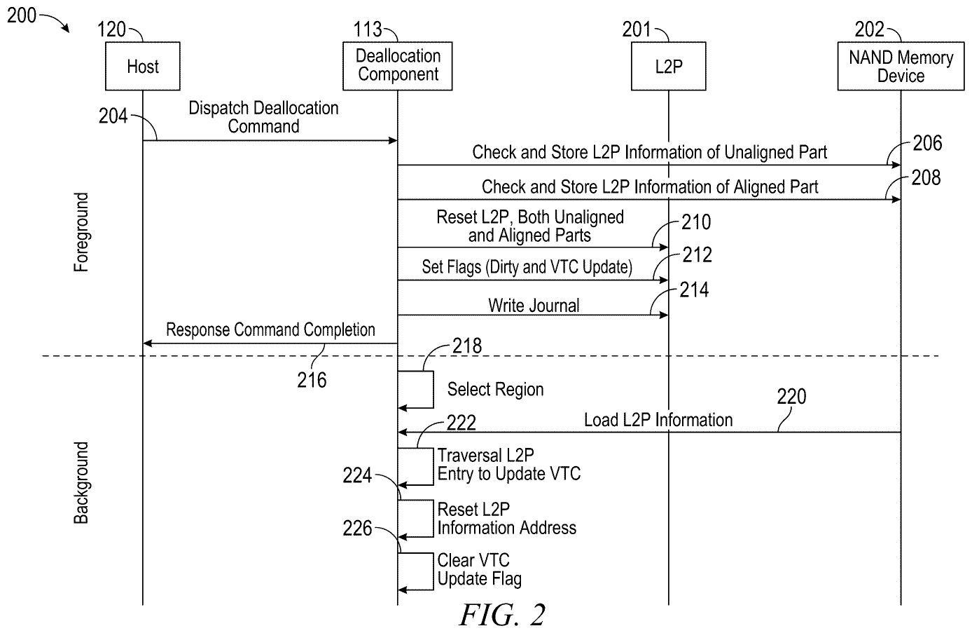

FIG. 2 is a data flow diagram illustrating interactions between components of the computing environment 100 in performing a method 200 for memory deallocation, in accordance with some examples. More specifically, FIG. 2 illustrates example interactions between the host system 120, the deallocation component 113, an L2P table 201, and a memory device 202 in performing a method 200. In the example illustrated in FIG. 2, memory device 202 is an example memory device 130 of FIG. 1 in the example form of a NAND memory device.

The memory device 202 includes multiple NAND dies. Each die may include one or more planes, and each plane includes multiple blocks. Each block includes a two-or three-dimensional array that includes pages (rows) and strings (columns). A string includes a plurality of memory cells connected in series. Each memory cell is used to represent one or more bit values. For example, a single NAND flash cell includes a transistor that stores an electric charge on a memory layer that is isolated by oxide insulating layers above and below. Within each cell, data is stored as the threshold voltage of the transistor. SLC NAND, for example, can store one bit per cell. Other types of memory cells, such as MLCs, TLCs, QLCs, and PLCs, can store multiple bits per cell. In this example, the NAND memory includes an SLC portion that includes multiple SLCs and a QLC portion that includes multiple QLCs.

As shown, a first sub-set of the operations of the method 200 is performed as part of foreground processing while a second sub-set of the operations of the method 200 is performed as part of background processing.

During foreground processing, the host system 120 dispatches a deallocation command to the deallocation component 113, at operation 204. The deallocation command includes a list of ranges, where each range contains a starting Logical Block Address (LBA), a length specified in logical blocks, and context attributes. These ranges represent the logical addresses that are to be deallocated based on the command.

The deallocation component 113 processes these ranges by first checking the list and merging overlapping or adjacent ranges. The merged ranges are then mapped to affected L2P regions, which are collections of contiguous L2P entries that are written/read from the memory device 202 as a unit. Each L2P region contains a fixed number of Translation Units (TUs), (e.g., 1024 TUs per region). When a deallocation range overlaps with an L2P region, that region becomes an “affected region” in the context of this disclosure. The overlap can be either:
1. Aligned—where the deallocation range completely covers all TUs in the region.
2. Unaligned—where the deallocation range only covers some TUs in the region, requiring special handling of the non-deallocated parts.

At operation 206, the deallocation component 113 checks and stores L2P information for unaligned parts of affected regions (also referred to herein as “unaligned regions”). This involves copying the deallocated parts to a new buffer while clearing mapping entries for non-deallocated parts. At operation 208, the deallocation component 113 checks and stores L2P information for the aligned parts of affected regions (also referred to herein as “aligned regions”) by copying the complete L2P mapping slice buffer to a new buffer. At operation 210, the deallocation component 113 resets the L2P entries for both unaligned and aligned regions by overwriting the mapping table entries with special values that indicate the entries are deallocated.

At operation 212, the deallocation component 113 sets flags, including one or more dirty flags for L2P drop functionality and one or more VTC update flags to indicate which regions need VTC updates during background processing. In an example, the deallocation component 113 maintains a bitmap data structure to track which regions need VTC updates during background deallocation. The bitmap can be implemented as continuous memory with a size equal to the L2P Region count divided by 8. When a bit is set (triggered) in the bitmap, it indicates that deallocation occurred for that region and VTC updates are needed. When the bit is cleared, it indicates the region is clean. Consistent with this example, the setting of a VTC update flag for a region includes setting a bit in the bitmap corresponding to the region to 1 to indicate that the region needs VTC updates.

The deallocation component 113, at operation 214, writes journal data to enable recovery operations after power-on events. The journal data includes information about the deallocation operations that have been performed, which allows the memory sub-system 110 to properly recover the state of deallocated regions and ensure data consistency when power is restored.

The deallocation component 113 sends a response to the host system 120 indicating command completion (operation 216).

During background processing, the deallocation component 113 selects a region for processing, at operation 218. In an example, the deallocation component 113 selects the region based on a first bit set to 1 in the bitmap data structure used to track regions requiring processing. The deallocation component 113, at operation 220, loads L2P information for the selected region from the NAND memory device 202 using the stored mapping address. The deallocation component 113 traverses the L2P entries to update the VTC by decreasing the count for block stripes containing deallocated addresses (operation 222). At operation 224, the deallocation component 113 resets the L2P information address and decreases the VTC count for the address itself, as the data it points to becomes invalid. In resetting the L2P information, the old mapping information in the L2P table is replaced with special values that indicate deallocation of corresponding L2P entries. At operation 226, the deallocation component 113 clears the VTC update flag to indicate that background deallocation is completed for this region.

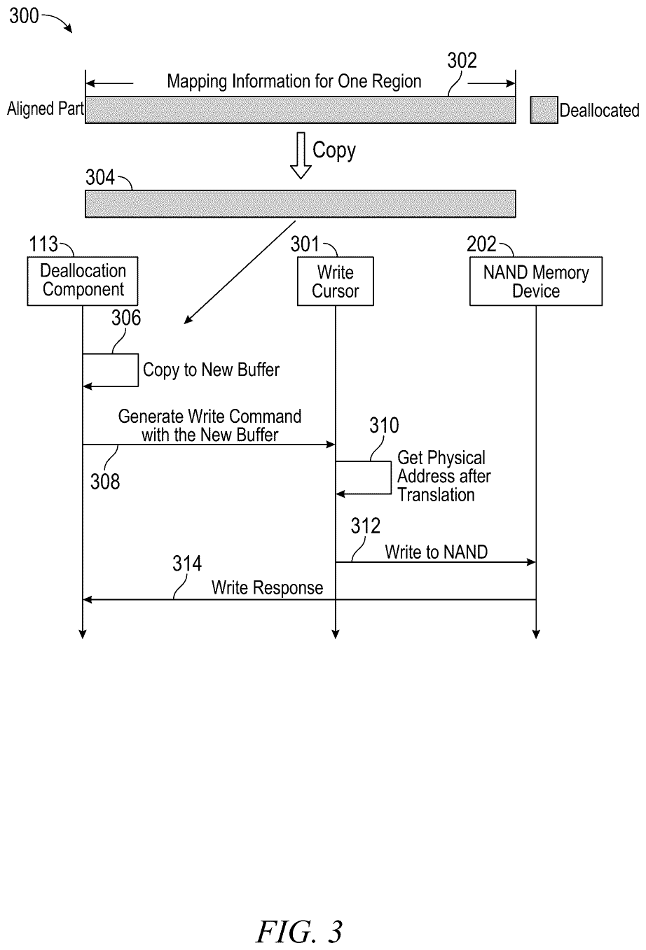

FIG. 3 is a flowchart illustrating a method 300 of storing mapping information for aligned regions during foreground deallocation operations, in accordance with some examples. FIG. 3 shows mapping information 302 that contains an aligned part of a region that requires deallocation processing. The mapping information 302 includes L2P entries that define the physical locations of TUs.

During foreground deallocation, the deallocation component 113 generates a copy 304 of the mapping information 302 from the L2P mapping slice buffer to preserve the current state of the mapping information before modification. The copying operation ensures that the original L2P mapping slice buffer remains available to accept new writes while the old mapping information is being stored.

After copying the mapping information to a new buffer (operation 306), the deallocation component 113 generates a write command that includes the newly copied buffer data (operation 308). At operation 310, the write cursor 301 obtains the physical address through address translation for writing the mapping information to the memory device 202. The write cursor 301 manages the sequential writing of mapping information to ensure proper storage organization.

Following address translation, at operation 312, the deallocation component 113 executes the write operation to store the mapping information in the memory device 202 at the translated physical address.

Upon completion of the write operation, the memory device 202 sends a write response to confirm the successful storage of the mapping information, at operation 314. This process preserves the mapping information for aligned regions before the L2P entries are reset, enabling subsequent VTC updates during background deallocation processing. The stored mapping information is maintained in extended LTU space, which is sized according to the L2P Region count multiplied by the Flash Logical Address (FLA) size.

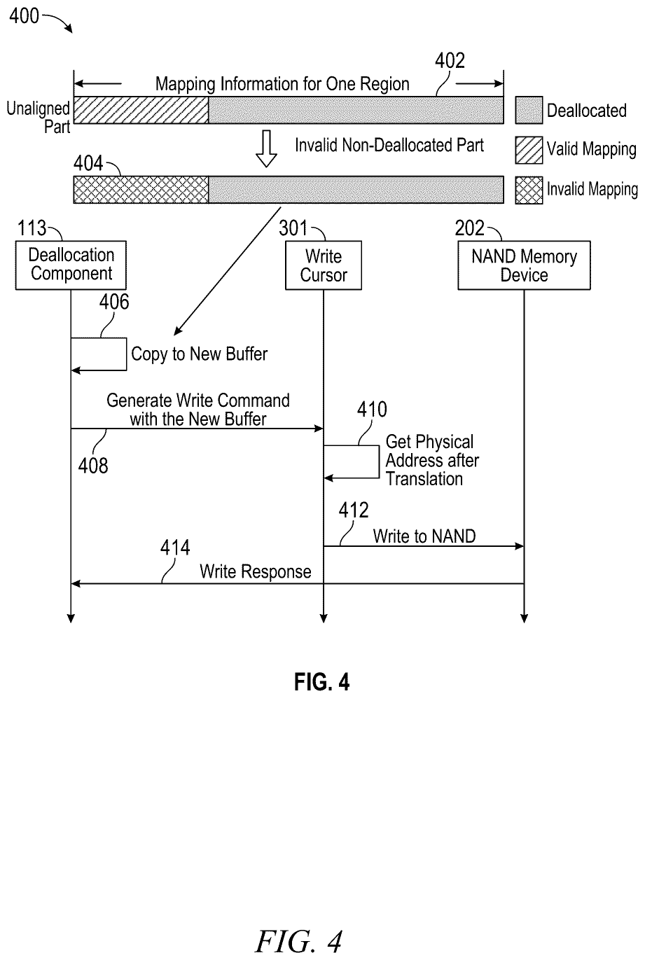

FIG. 4 is a flowchart illustrating a method 400 of storing mapping information for unaligned regions during foreground deallocation operations, in accordance with some examples. FIG. 4 shows mapping information 402 that contains an unaligned part that requires deallocation processing. The unaligned part includes both deallocated portions and invalid non-deallocated portions, where the mapping entries are divided into valid mapping and invalid mapping sections.

The deallocation component 113 processes the unaligned region by generating a copy 404 of only the deallocated portions and storing the copy 404 in a new buffer (at operation 406), while clearing the mapping entries for the non-deallocated parts. This selective copying ensures that only the relevant mapping information is preserved for subsequent VTC updates.

After copying the selected mapping information to a new buffer, the deallocation component 113 generates a write command that includes the newly copied buffer data, at operation 408. At operation 410, the write cursor 301 obtains the physical address through address translation for writing the mapping information to the memory device 202.

Following address translation, the deallocation component 113 executes the write operation to store the mapping information in the memory device 202 at the translated physical address, at operation 412. Upon completion of the write operation, the memory device 202 sends a write response to confirm the successful storage of the mapping information, at operation 414.

As described, the method 400 preserves only the deallocated portions of unaligned regions before the L2P entries are reset, enabling subsequent VTC updates during background deallocation processing. The stored mapping information is maintained in extended LTU space, which allows for efficient management of the preserved mapping data.

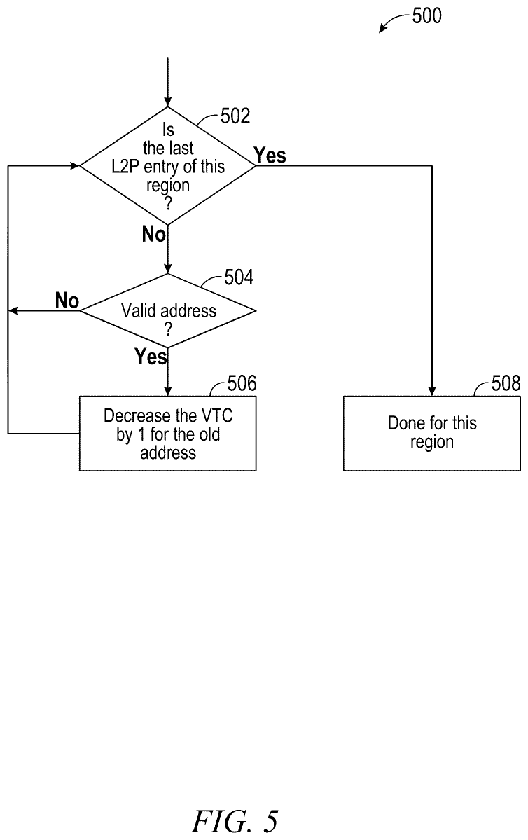

FIG. 5 is a flowchart illustrating a method 500 of updating VTC values during background deallocation operations, in accordance with some examples. Consistent with some examples, the method 500 can be performed as part of operation 222 of FIG. 2.

At operation 502, the deallocation component 113 of FIG. 1 checks whether the current L2P entry is the last entry of the selected region. This check allows the deallocation component 113 to track progress through all entries in the region that are flagged for VTC updates.

At operation 504, when the entry is not the last in the region, the deallocation component 113 checks whether the address in the current L2P entry is valid. The deallocation component 113 examines the mapping information that was previously stored during foreground deallocation to determine the validity of the address.

At operation 506, when a valid address is found, the deallocation component 113 decreases the VTC by one for the block stripe that the old mapping address pointed to.

At operation 508, based on all entries having been processed, the deallocation component 113 completes the VTC update process for the current region. The completion of this process enables the deallocation component 113 to proceed with resetting the L2P information address and clearing the VTC update flag for the processed region.

Method 500 demonstrates how the deallocation component 113 traverses through each L2P mapping entry in the region, processing entries one by one to update the VTC counts for affected block stripes. This process continues until all entries in the region have been evaluated and their corresponding VTC values have been appropriately adjusted.

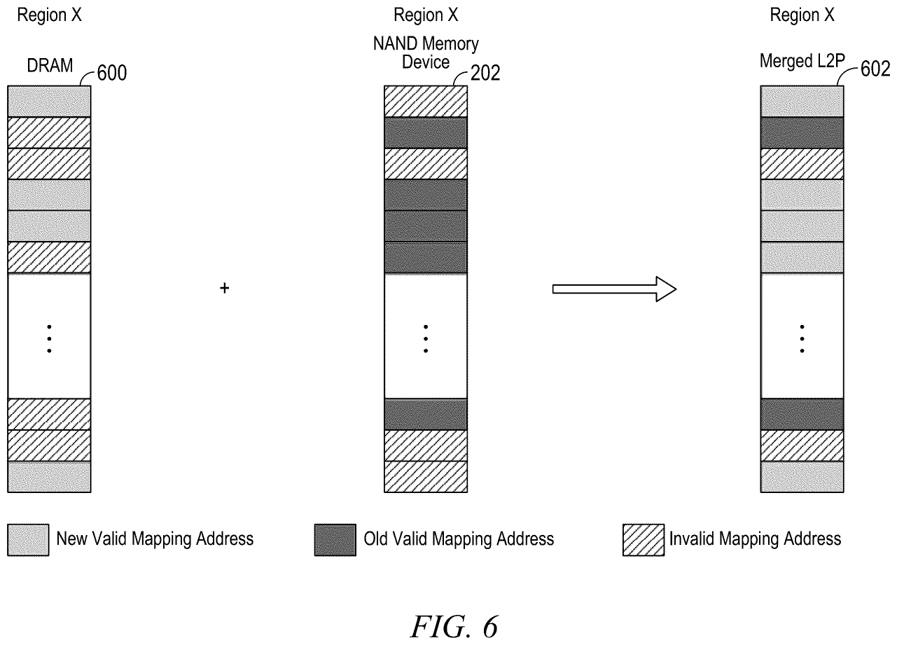

FIG. 6 is a conceptual diagram that illustrates a process for merging mapping information when a region (illustrated as “Region X”) undergoes multiple deallocation operations before background processing completes, in accordance with some examples. In FIG. 6, DRAM 600 stores current mapping information for the region with new valid mapping addresses that have been written since the previous deallocation.

The memory device 202 stores the previous mapping information for the region with old valid mapping addresses that were stored during the earlier deallocation operation but have not yet completed background processing.

The merged L2P table 602 represents the combined mapping information for the region that results from merging the mapping data from DRAM 600 and the NAND memory device 202. The merging process handles four different cases for each mapping entry:
1. When both the new mapping address from DRAM 600 and old mapping address from the memory device 202 are valid, the old mapping address completes VTC updates, and the merged entry contains the new mapping address.
2. When the new mapping address is valid, but the old mapping address is invalid, the merged entry is updated to contain the new mapping address.
3. When the new mapping address is invalid, but the old mapping address is valid, no changes are made to the mapping entry.
4. When both the new and old mapping addresses are invalid, no changes are made to the mapping entry.

This merging process ensures that the VTC updates properly account for all mapping changes that occurred between successive deallocation operations on the same region.

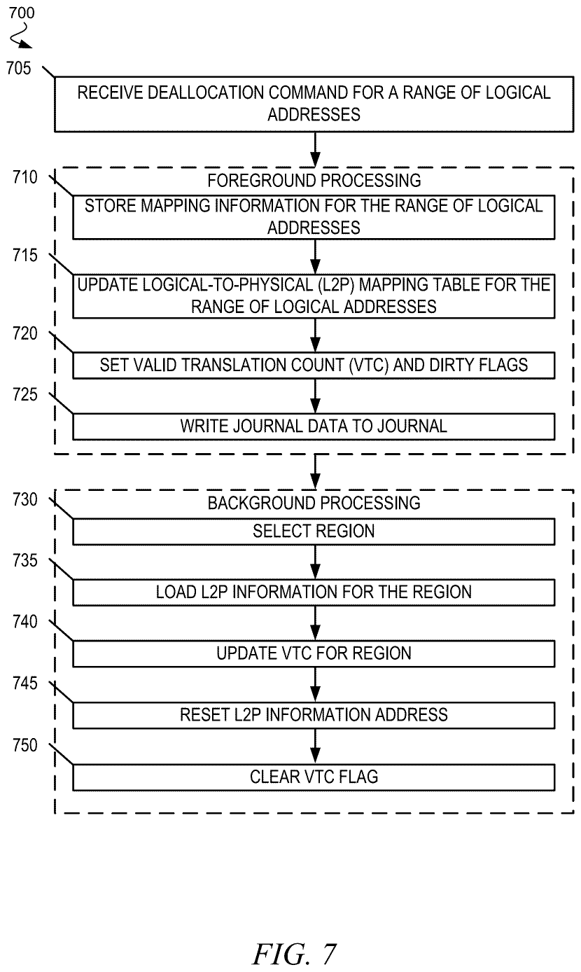

FIG. 7 is a flow diagram illustrating an example method 700 for performing memory deallocation for a memory device, in accordance with some examples. The method 700 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 700 is performed by the deallocation component 113 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment; other process flows are possible.

At operation 705, a processing device receives a deallocation command for a range of logical addresses. The deallocation command provides a list of ranges, where each range comprises a starting Logical Block Address (LBA), a length specified in logical blocks, and context attributes.

As shown, the processing device separates operations performed in processing the deallocation command into foreground processing and background processing.

At operation 710, the processing device stores mapping information for the range of logical addresses. The mapping information comprises L2P mapping entries that define the physical locations of TUs and mapping addresses that point to valid write data. The storing of the mapping information comprises copying current L2P mapping information to a buffer and writing the buffer to non-volatile memory. The processing device stores the L2P information for both aligned and unaligned regions corresponding to the range of logical addresses. For unaligned regions, the processing device identifies and stores mapping information only for the deallocated parts while mapping entries for non-deallocated parts are cleared before storage. For aligned regions, the processing device stores the complete mapping information for the region.

At operation 715, the processing device updates the L2P mapping table for the range of logical addresses by resetting L2P entries corresponding to the range of logical addresses. Resetting L2P entries includes overwriting mapping table entries with invalid addresses. In an example, the old mapping information for an entry in the L2P table is replaced with a special value that indicates the entry has been deallocated. In some examples, the special value results in specific patterns, such as all zeros or all FFs, being returned when the entries are subsequently read. In some examples, the reset operation is executed using DMA operations to efficiently set the entries to the special value.

By performing the reset operation in the foreground rather than the background, the processing device ensures that mapping information is always current and accurate. This approach enables subsequent read operations to directly determine the deallocated status from the L2P entry value without needing to check additional flags. When the host reads these reset entries, it will receive appropriate data patterns based on the special values stored in the entries that indicate the entries have been deallocated.

At operation 720, the processing device sets valid translation unit count (VTC) and dirty flags. The dirty flag is used to manage L2P drop functionality, while the VTC update flag indicates that the region needs to process VTC updates in background deallocation. In some examples, the processing device maintains a bitmap structure to track which regions need a VTC update and in these examples, setting the VTC update flag comprises setting a bit corresponding to the region to 1 in the bitmap.

At operation 725, the processing device writes journal data to the journal for recovery after power-on operations.

At operation 730, the processing device begins background processing by selecting a region. The region selection process involves finding the first bit set to 1 in a bitmap of regions requiring processing.

At operation 735, the processing device loads L2P information for the selected region from the memory device using the stored mapping address.

At operation 740, the processing device updates the VTC for the region by traversing the L2P mapping entries and decreasing the VTC count for block stripes containing deallocated addresses. For each valid mapping entry encountered, the processing device decreases the VTC count by 1 for the block stripe that the old mapping address pointed to, effectively updating the count of valid TUs contained in each affected block stripe. The VTC update continues until all L2P entries in the region have been processed, ensuring accurate tracking of valid TUs across all affected block stripes.

At operation 745, the processing device resets the L2P information address based on the VTC updates being complete. Resetting the L2P information address includes clearing the address that points to the old mapping information that was stored (e.g., in extended LTU space) during foreground processing. When resetting the L2P information address, the processing device also decreases the VTC count for the address itself, since the data it points to becomes invalid once all L2P entries have completed their VTC updates.

At operation 750, the processing device clears the VTC flag to indicate that background deallocation is completed for this region.

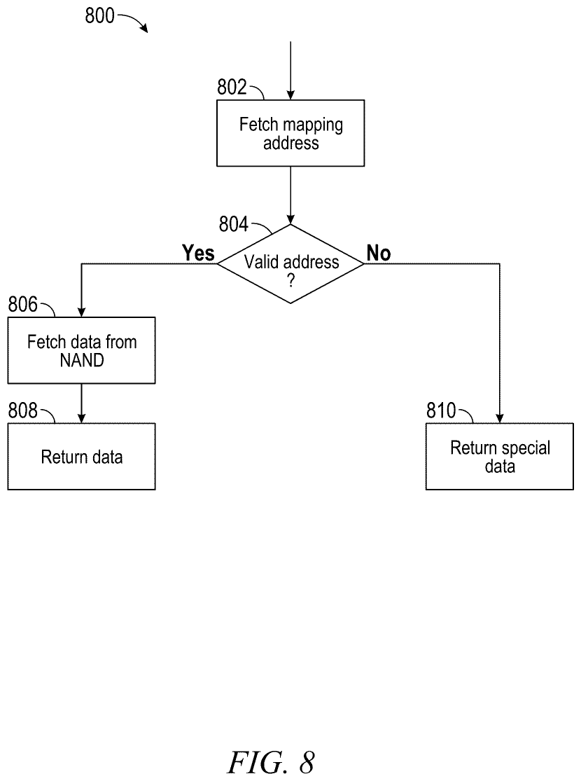

FIG. 8 is a flowchart illustrating a method 800 of handling host read operations after deallocation processing, in accordance with some examples. The method 800 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 800 is performed by the memory sub-system controller 115 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment; other process flows are possible.

In the context of method 800, a read command directed at a logical address is received from a host system.

At operation 802, the processing device fetches a mapping address for a logical address included in the read request received from the host system. That is, the processing device retrieves the current L2P mapping entry to determine the physical location of the requested data.

At operation 804, the processing device checks whether the fetched mapping address is valid. Since L2P entries are reset during foreground deallocation, this check determines whether the address points to valid data or indicates a deallocated state.

At operation 806, when a valid address is found, the processing device fetches the data from a memory device using the physical address obtained from the mapping.

At operation 808, after retrieving the data, the processing device returns the fetched data to the host. This completes the read operation for valid addresses.

At operation 810, when an invalid address is found, the processing device returns special data to the host system. The special data can be configured to comprise special patterns based on the type of invalid mapping-for example, returning all zeros for deallocated addresses or all ones (0xFF) for unmapped addresses.

Thus, FIG. 8 demonstrates how the processing device processes host read requests by checking the validity of mapping addresses and returning either the actual data or special data based on the mapping state.

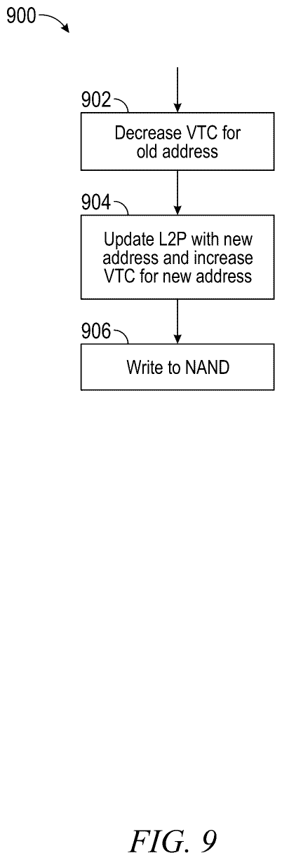

FIG. 9 is a flowchart illustrating a method 900 of handling host write operations after deallocation processing, in accordance with some examples. The method 900 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 900 is performed by the memory sub-system controller 115 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment; other process flows are possible.

In the context of method 900, a write command comprising write data is received from a host system.

At operation 902, the processing device decreases the VTC for the old address. The “old address” refers to the previous physical address stored in the L2P mapping entry before a new write operation updates it with a new physical location. When the L2P entry has been deallocated, this operation can be skipped since the old address is already invalid.

At operation 904, the processing device updates the L2P entry with the new address and increases the VTC for the new address. This operation updates the mapping table to reflect the new physical location of the data and adjusts the VTC for the affected block stripe.

At operation 906, the processing device writes the write data to the memory device at the new physical address. This operation completes the host write process by storing the data at its new location.

Thus, FIG. 9 demonstrates how the deallocation component 113 processes host write requests by updating the VTC counts and L2P mappings without checking deallocation flags or implementing priority deallocation, since the L2P entries are always maintained with the latest mapping information.

Described implementations of the subject matter can include one or more features, alone or in combination, as illustrated below by way of example.

Example 1. A memory sub-system comprising: a memory device; a processing device, operatively coupled with the memory device, to perform operations comprising: receiving a deallocation command for a range of logical addresses corresponding to one or more regions of the memory device; in response to the deallocation command, performing, in foreground processing, operations comprising: storing mapping information for the range of logical addresses; updating a logical-to-physical (L2P) mapping table by resetting one or more L2P entries for the range of logical addresses; setting one or more valid translation unit count update flags for the one or more regions of the memory device corresponding to the range of logical addresses; and based on the setting of the valid translation unit count update flags, performing, in background processing, updates to valid translation unit counts for the one or more regions based on the mapping information.

Example 2. The memory sub-system of Example 1, wherein the background processing comprises: selecting a region having a set valid translation unit count update flag; loading stored mapping information for the selected region; the updating valid translation unit counts for the one or more regions comprises: traversing L2P entries in the loaded mapping information; and decreasing valid translation unit counts for one or more block stripes corresponding to one or more invalid addresses in the loaded mapping information.

Example 3. The memory sub-system of any one or more of Examples 1 or 2, wherein the operations comprise clearing the valid translation unit count flag for the selected region based on decreasing valid translation unit counts for the one or more block stripes.

Example 4. The memory sub-system of any one or more of Examples 1-3, wherein storing mapping information comprises: copying current L2P mapping information to a buffer; and writing the buffer to non-volatile memory.

Example 5. The memory sub-system of any one or more of Examples 1-4, wherein the range of logical addresses spans an unaligned region, and storing mapping information comprises storing mapping information only for deallocated portions of the unaligned region.

Example 6. The memory sub-system of any one or more of Examples 1-5, wherein setting update flags comprises setting one or more bits in a bitmap corresponding to the one or more regions.

Example 7. The memory sub-system of any one or more of Examples 1-6, wherein updating the L2P mapping table comprises setting the one or more L2P entries to invalid addresses.

Example 8. The memory sub-system of any one or more of Examples 1-7, wherein setting the one or more L2P entries to invalid addresses comprises setting an L2P entry to a special value to indicate the entry is deallocated.

Example 9. The memory sub-system of any one or more of Examples 1-8, wherein the operations comprise: receiving a read command directed at a logical address in the range of logical addresses; and returning special data in response to the read command based on the logical address being invalid, the special data comprising a special pattern, indicating deallocation of the logical address.

Example 10. A method comprising: receiving, by a processing device, a deallocation command for a range of logical addresses corresponding to one or more regions of a memory device; in response to the deallocation command, performing, in foreground processing by the processing device, operations comprising: storing mapping information for the range of logical addresses; updating a logical-to-physical (L2P) mapping table by resetting L2P entries for the range of logical addresses; setting valid translation unit count update flags for the one or more regions of the memory device corresponding to the range of logical addresses; and based on the setting of the valid translation unit count update flags, performing, in background processing by the processing device, updates to valid translation unit counts for the one or more regions based on the mapping information.

Example 11. The method of Example 10, wherein the background processing comprises: selecting a region having a set valid translation unit count update flag; loading stored mapping information for the selected region; and the updating valid translation unit counts for the one or more regions comprises: traversing L2P entries in the loaded mapping information; and decreasing valid translation unit counts for one or more block stripes corresponding to one or more invalid addresses in the loaded mapping information.

Example 12. The method of any one or more of Examples 10 or 11, wherein the operations comprise clearing the valid translation unit count flag for the selected region based on decreasing valid translation unit counts for the one or more block stripes.

Example 13. The method of any one or more of Examples 10-12, wherein storing mapping information comprises: copying current L2P mapping information to a buffer; and writing the buffer to non-volatile memory.

Example 14. The method of any one or more of Examples 10-13, wherein the range of logical addresses spans an unaligned region, and storing mapping information comprises storing mapping information only for deallocated portions of the unaligned region.

Example 15. The method of any one or more of Examples 10-14, wherein setting update flags comprises setting one or more bits in a bitmap corresponding to the one or more regions.

Example 16. The method of any one or more of Examples 10-15, wherein updating the L2P mapping table comprises setting the one or more L2P entries to invalid addresses.

Example 17. The method of any one or more of Examples 10-16, wherein setting the one or more L2P entries to invalid addresses comprises setting an L2P entry to a special value to indicate the entry is deallocated.

Example 18. The method of any one or more of Examples 10-17, wherein the operations comprise: receiving a read command directed at a logical address in the range of logical addresses; and returning special data in response to the read command based on the logical address being invalid, the special data comprising a special pattern indicating deallocation of the logical address.

Example 19. A computer-readable storage medium comprising instructions that, when executed by a processing device, configure the processing device to perform operations comprising: receiving a deallocation command for a range of logical addresses corresponding to one or more regions of a memory device; in response to the deallocation command, performing, in foreground processing, operations comprising: storing mapping information for the range of logical addresses; updating a logical-to-physical (L2P) mapping table by resetting L2P entries for the range of logical addresses; setting valid translation unit count update flags for the one or more regions of the memory device corresponding to the range of logical addresses; and based on the setting of the valid translation unit count update flags, performing, in background processing, updates to valid translation unit counts for the one or more regions based on the mapping information.

Example 20. The computer-readable storage medium of Example 19, wherein: the background processing comprises: selecting a region having a set valid translation unit count update flag; loading stored mapping information for the selected region; and the updating valid translation unit counts for the one or more regions comprises: traversing L2P entries in the loaded mapping information; and decreasing valid translation unit counts for one or more block stripes corresponding to one or more invalid addresses in the loaded mapping information.

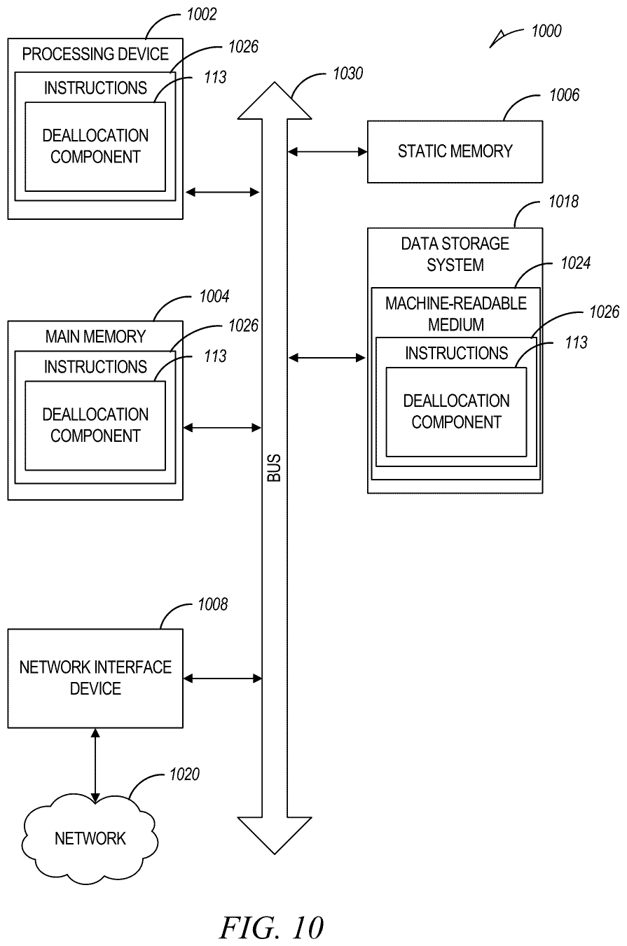

FIG. 10 illustrates an example machine in the form of a computer system within which a set of instructions can be executed for causing the machine to perform any one or more of the methodologies discussed herein. FIG. 10 illustrates an example machine of a computer system 1000 within which a set of instructions, for causing the machine to perform any one or more of the methodologies discussed herein, can be executed. In some embodiments, the computer system 1000 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the deallocation component 113 of FIG. 1). In alternative embodiments, the machine can be connected (e.g., networked) to other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a main memory 1004 (e.g., ROM, flash memory, DRAM such as SDRAM or RDRAM, etc.), a static memory 1006 (e.g., flash memory, static random access memory (SRAM), etc.), and a data storage system 1018, which communicate with each other via a bus 1030.

Processing device 1002 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1002 can also be one or more special-purpose processing devices such as an ASIC, a FPGA, a digital signal processor (DSP), network processor, or the like. The processing device 1002 is configured to execute instructions 1026 for performing the operations and steps discussed herein. The computer system 1000 can further include a network interface device 1008 to communicate over a network 1020.

The data storage system 1018 can include a machine-readable storage medium 1024 (also known as a computer-readable medium) on which is stored one or more sets of instructions 1026 or software embodying any one or more of the methodologies or functions described herein. The instructions 1026 can also reside, completely or at least partially, within the main memory 1004 and/or within the processing device 1002 during execution thereof by the computer system 1000, the main memory 1004 and the processing device 1002 also constituting machine-readable storage media. The machine-readable storage medium 1024, data storage system 1018, and/or main memory 1004 can correspond to the memory sub-system 110 of FIG. 1.

In one embodiment, the instructions 1026 include instructions to implement functionality corresponding to a deallocation component (e.g., the deallocation component 113 of FIG. 1). While the machine-readable storage medium 1024 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here and, generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, etc.

In the foregoing specification, embodiments of the disclosure have been described with reference to specific example embodiments thereof. It will be evident that various modifications can be made thereto without departing from the broader scope of embodiments of the disclosure as set forth in the following claims. The specification and drawings are, accordingly, to be regarded in an illustrative sense rather than a restrictive sense.

1. A memory sub-system comprising:
a memory device;
a processing device, operatively coupled with the memory device, to perform operations comprising:
receiving a deallocation command for a range of logical addresses corresponding to one or more regions of the memory device;
in response to the deallocation command, performing, in foreground processing, operations comprising:
storing mapping information for the range of logical addresses;
updating a logical-to-physical (L2P) mapping table by resetting one or more L2P entries for the range of logical addresses;
setting one or more valid translation unit count update flags for the one or more regions of the memory device corresponding to the range of logical addresses;
writing, to a journal, journal data for the range of logical addresses to enable recovery of a deallocation state of the one or more regions of the memory device after a power-on event; and
based on the setting of the one or more valid translation unit count update flags, performing, in background processing, updates to valid translation unit counts for the one or more regions based on the mapping information.

2. The memory sub-system of claim 1, wherein the background processing comprises:
selecting a region having a set valid translation unit count update flag;
loading stored mapping information for the selected region;
the updating valid translation unit counts for the one or more regions comprises:
traversing L2P entries in the loaded mapping information; and
decreasing valid translation unit counts for one or more block stripes corresponding to one or more invalid addresses in the loaded mapping information.

3. The memory sub-system of claim 2, wherein the operations comprise clearing the valid translation unit count flag for the selected region based on decreasing valid translation unit counts for the one or more block stripes.

4. The memory sub-system of claim 1, wherein storing mapping information comprises:
copying current L2P mapping information to a buffer; and
writing the buffer to non-volatile memory.

5. The memory sub-system of claim 1, wherein the range of logical addresses spans an unaligned region, and storing mapping information comprises storing mapping information only for deallocated portions of the unaligned region.

6. The memory sub-system of claim 5, wherein setting update flags comprises setting one or more bits in a bitmap corresponding to the one or more regions.

7. The memory sub-system of claim 1, wherein updating the L2P mapping table comprises setting the one or more L2P entries to invalid addresses.

8. The memory sub-system of claim 7, wherein setting the one or more L2P entries to invalid addresses comprises setting an L2P entry to a special value to indicate the entry is deallocated.

9. The memory sub-system of claim 8, wherein the operations comprise:
receiving a read command directed at a logical address in the range of logical addresses; and
returning special data in response to the read command based on the logical address being invalid, the special data comprising a special pattern, indicating deallocation of the logical address.

10. A method comprising:
receiving, by a processing device, a deallocation command for a range of logical addresses corresponding to one or more regions of a memory device;
in response to the deallocation command, performing, in foreground processing by the processing device, operations comprising:
storing mapping information for the range of logical addresses;
updating a logical-to-physical (L2P) mapping table by resetting L2P entries for the range of logical addresses;
setting valid translation unit count update flags for the one or more regions of the memory device corresponding to the range of logical addresses;
writing, to a journal, journal data for the range of logical addresses to enable recovery of a deallocation state of the one or more regions of the memory device after a power-on event; and
based on the setting of the valid translation unit count update flags, performing, in background processing by the processing device, updates to valid translation unit counts for the one or more regions based on the mapping information.

11. The method of claim 10, wherein the background processing comprises:
selecting a region having a set valid translation unit count update flag;
loading stored mapping information for the selected region; and
the updating valid translation unit counts for the one or more regions comprises:
traversing L2P entries in the loaded mapping information; and
decreasing valid translation unit counts for one or more block stripes corresponding to one or more invalid addresses in the loaded mapping information.

12. The method of claim 11, wherein the operations comprise clearing the valid translation unit count flag for the selected region based on decreasing valid translation unit counts for the one or more block stripes.

13. The method of claim 10, wherein storing mapping information comprises:
copying current L2P mapping information to a buffer; and
writing the buffer to non-volatile memory.

14. The method of claim 10, wherein the range of logical addresses spans an unaligned region, and storing mapping information comprises storing mapping information only for deallocated portions of the unaligned region.

15. The method of claim 13, wherein setting update flags comprises setting one or more bits in a bitmap corresponding to the one or more regions.

16. The method of claim 10, wherein updating the L2P mapping table comprises setting the one or more L2P entries to invalid addresses.

17. The method of claim 16, wherein setting the one or more L2P entries to invalid addresses comprises setting an L2P entry to a special value to indicate the entry is deallocated.

18. The method of claim 17, wherein the operations comprise:
receiving a read command directed at a logical address in the range of logical addresses; and
returning special data in response to the read command based on the logical address being invalid, the special data comprising a special pattern indicating deallocation of the logical address.

19. A non-transitory computer-readable storage medium comprising instructions that, when executed by a processing device, configure the processing device to perform operations comprising:
receiving a deallocation command for a range of logical addresses corresponding to one or more regions of a memory device;
in response to the deallocation command, performing, in foreground processing, operations comprising:
storing mapping information for the range of logical addresses;
updating a logical-to-physical (L2P) mapping table by resetting L2P entries for the range of logical addresses;
setting valid translation unit count update flags for the one or more regions of the memory device corresponding to the range of logical addresses;
writing, to a journal, journal data for the range of logical addresses to enable recovery of a deallocation state of the one or more regions of the memory device after a power-on event; and
based on the setting of the valid translation unit count update flags, performing, in background processing, updates to valid translation unit counts for the one or more regions based on the mapping information

20. The non-transitory computer-readable storage medium of claim 19, wherein:
the background processing comprises:
selecting a region having a set valid translation unit count update flag;
loading stored mapping information for the selected region; and
the updating valid translation unit counts for the one or more regions comprises:
traversing L2P entries in the loaded mapping information; and
decreasing valid translation unit counts for one or more block stripes corresponding to one or more invalid addresses in the loaded mapping information.
